(19) United States
(12) Patent Application Publication
(10) Pub. No.: US 2025/0007338 A1
(43) Pub. Date: Jan. 2, 2025

(54) ELECTRIC MACHINE STATOR

(71) Applicant: GKN Automotive Limited, Birmingham (GB)

(72) Inventors: Jon García Urbieta, Zumaia (ES); Iñigo García Sierra, Zumaia (ES); Oscar Baonza, Zumaia (ES); Pablo Granados, Zumaia (ES)

(21) Appl. No.: 18/616,232

(22) Filed: Mar. 26, 2024

(30) Foreign Application Priority Data
Jun. 30, 2023 (DE) 10 2023 117 408.8

(51) Int. Cl. H02K 1/20; H02K 9/19

(52) U.S. Cl. CPC H02K 1/20; H02K 9/19

(57) ABSTRACT

An electric machine stator including a stator core, a stator winding attached to the stator core, a plurality of cooling channels extending through the stator core, and two manifolds attached to opposed axial ends of the stator core for conveying a fluid into the cooling channels. Each of the two manifolds having a distribution channel hydraulically connected to a share of the cooling channels, wherein a flow cross-section of the distribution channel decreases along a circumferential main extension direction of the distribution channel.

### CROSS-REFERENCE TO RELATED APPLICATIONS

This application claims priority to German Application No. DE 10 2023 117 408.8, filed on Jun. 30, 2023, which application is hereby incorporated herein by reference in its entirety.

### BACKGROUND

It is known that in the operation of electric machines such as generators or electric motors used to power automotive vehicles heat losses or copper losses occur. In order to avoid thermal overheating which would lead to lowered efficiency or even to damage or a reduction of the lifetime, particularly the insulation lifetime of the respective electric machine, cooling systems are provided.

CN 207475301 U discloses an electric motor cooling system in which a plurality of axial coolant channels is integrated into the stator teeth. The axis of each of the axial coolant channels is parallel with the axis of the stator. A coolant manifold assembly that is integrated into the stator fluidly couples the coolant channels within the stator to the source of coolant.

US 2021/351642 A1 discloses an electric motor cooling system that utilizes stator-integrated axial coolant channels and a coolant manifold centrally located within the stator to efficiently remove heat. The coolant manifold includes a middle member that allows coolant to enter the axial coolant channels via transition laminations, where the transition laminations include coolant distribution channels that direct the flow of coolant entering into the manifold into the stator-integrated axial coolant channels.

CN 112886735 A discloses a motor stator assembly with a cooling flow channel. The stator comprises a stator support and a stator lamination which are nested with each other, the stator lamination being provided with a stator winding. The stator winding protrudes out of the end part of the stator lamination in the axial direction, the stator support being provided with a liquid inlet hole penetrating through the peripheral wall of the stator support. A cooling groove is formed between the opposite peripheral walls of the stator support and the stator lamination, the cooling groove being communicated with the liquid inlet hole and open towards the two end portions of the stator lamination in the axial direction to form a liquid outlet. Cooling liquid flows into the cooling groove from the liquid inlet hole and flow out of the cooling groove from the liquid outlet, so the stator lamination and the stator winding are cooled.

### SUMMARY

The electric machine stator comprises a stator core, a stator winding attached to the stator core, a plurality of cooling channels extending through the stator core, and two manifolds attached to opposed axial ends of the stator core for conveying a fluid into the cooling channels. Each of the two manifolds have a distribution channel hydraulically connected to a share of the cooling channels, and a flow cross-section of the distribution channel decreases along a main circumferential extension direction of the distribution channel.

Through the two manifolds the cooling fluid may advantageously be conveyed to the cooling channels from both axial ends of the stator instead of a central inlet know from the state of the art. The decreasing flow cross-sections of the distribution channels provide a more even distribution of pressure and flow velocity of the cooling fluid.

The generally cylindrical stator core can define a longitudinal axis, in relation to which any statements regarding axial, radial or circumferential directions are to be understood. The stator winding attached to the stator core can be a hairpin winding. The cooling channels can extend generally from one axial end of the stator core to the other. The cooling channels can extend straight and in parallel to the longitudinal axis, for example, or spirally around the longitudinal axis, or with decreasing or increasing radial distance to the longitudinal axis. The decreasing flow cross-section of the distribution channel is to be understood as a decrease in cross-sectional area of the distribution channel, the cross-sectional area being defined in a plane to which a flow direction of the cooling fluid is perpendicular. The flow cross-section of the cooling channels can be of round or quadrangular form, for example. The manifolds can be made of a plastic material and are generally circular. The distribution channel extends circumferentially along the manifold. The flow cross-section of the distribution channel can be rectangular in form, for example, while other forms are feasible as well. The decrease in flow cross-section of the distribution channel can be continuous or by a discrete number of steps. For example, the distribution channel can have a constant height in radial direction and a decreasing width in axial direction along the circumferential main extension direction. The person skilled in the art is aware that, alternatively or additionally, the height in radial direction of the distribution channel can be decreased along the circumferential main extension direction. The circumferential main extension direction conforms to the flow direction of the cooling fluid.

The two manifolds can be identical. When features of the manifolds are referred to in singular, it is to be understood that the feature is present in both manifolds. The two manifolds can also be referred to as a first manifold of the two manifolds having a first distribution channel hydraulically connected to a first share of the cooling channels, and a second manifold of the two manifolds having a second distribution channel hydraulically connected to a second share of the cooling channels, wherein a flow cross-section of the first distribution channel decreases along the circumferential main extension of the first distribution channel and a flow cross-section of the second distribution channel decreases along the circumferential main extension of the second distribution channel.

According to an embodiment, the distribution channel is circular, and the flow cross-section of the distribution channel decreases from a position of maximum flow cross-section in both circumferential directions. Advantageously, the fluid can be fed to the distribution channel at the position of maximum flow cross-section. A position of minimum flow cross-section of the distribution channel can be at an angular distance of about 180° from the position of maximum flow cross-section on the circumference of the distribution channel. Each manifold can have an inlet located at the position of maximum flow cross-section, but the inlet can be formed by another part than the manifold. The position of maximum flow cross-section is the position along the main extension direction of the distribution channel with the highest cross sectional area. The position of minimum flow cross-section is the position along the main extension direction of the distribution channel with the lowest cross sectional area.

According to a further embodiment, the cooling channels are evenly distributed about a circumference of the stator core, and connected hydraulically to one of the two manifolds according to an alternating pattern. If the cooling channels are, for example, alternatingly connected to one of the two manifolds, the coolant flow in each cooling channel is in counterflow to the respective adjacent cooling channel. As heat is transferred to the coolant during its flow through the cooling channel, the coolant temperature is lower at the introduction side and increases along the cooling channel. The interleaved first and second shares of the cooling channels advantageously balance the cooling effect and provide a more uniform temperature distribution along the stator core. Various alternating patterns of the first and second shares of the cooling channels can be implemented, instead of A-B-A-B-A-B- etc, for example, A-A-B-B-A-A-B-B- etc, or A-A-B-A-B-B-A-B-A-A-B-A- etc, with A representing the first share and B representing the second share.

According to a further embodiment, each of the two manifolds has outlet channels hydraulically connected to the share of cooling channels that are hydraulically connected to the distribution channel of the respective other one of the two manifolds, to receive the fluid from said share of cooling channels. The first manifold has first outlet channels, which are hydraulically connected to the second share of cooling channels, and the second manifold has second outlet channels, which are hydraulically connected to the first share of cooling channels. The outlet channels can have one or more openings for dispensing the fluid. The fluid can advantageously be used to cool the winding heads of the stator winding extending at both axial ends out of the stator core. The openings can be directed towards the winding heads to dispense the fluid onto the winding heads. The manifolds can be arranged axially overlapping and radially outside the winding heads. Two or three openings can be provided per outlet channel at different axial positions to advantageously cover the winding heads in the axial direction. Further, at least one of the openings can be directed in radial direction perpendicular to the axial direction, and at least one further opening can be directed in radial direction and angled to the axial direction.

According to a further embodiment, the distribution channel is formed as a groove in the manifold, the groove being closed by a housing encasing the stator core. The housing has at least one inlet hydraulically connected to the distribution channels. Cooling fluid is fed via the at least one inlet into the cooling channels. A single inlet can be hydraulically connected to both distribution channels via two feeding channels, which extend axially along or through the stator core. Alternatively, the housing can have two inlets, each hydraulically connected to one of the distribution channels. Advantageously, the two feeding channels or the two inlets can be arranged at the position of maximum flow cross-section of the distribution channel. Further, the stator can be mounted with the at least one inlet in a position of maximum potential energy, i.e. on top of the stator in its mounted position. A cooling circuit can advantageously be passive, without external pressurization, the cooling fluid being conveyed from a reservoir at a position of higher potential energy through the inlets to the distribution channels into the cooling channels, further through the outlet channels and the openings to the winding heads.

According to a further embodiment, the manifolds have positioning means to preserve a relative circumferential position in respect to the stator core. The manifolds can each have a gap in the circumferential direction, the manifolds accordingly having a C-form. The gap can be located at an angular distance of about 180° from the position of maximum flow cross-section. The C-form facilitates the installation of the manifolds inside the housing. A resilient member can be arranged between two surfaces facing the gap and biassing the two surfaces apart. The radial dimension of the manifolds can thus be reduced for installation, while the resilient member increases the radial dimension of the manifold again after installation. The resilient member can be a rubber seal arranged in grooves in the surfaces facing the gap.

According to a further embodiment, the stator core is composed of a plurality of identical laminations, which is advantageous in manufacturing the stator core as only one kind of metal sheet lamination needs to be produced. Alternatively, the stator core can be made in one piece, i.e. as a non-laminated stator core or solid stator core. A one piece stator core offers simplicity in manufacturing and assembly but it has drawbacks such as increased eddy current losses resulting in reduced efficiency.

### BRIEF DESCRIPTION OF THE DRAWINGS

FIG. 1 shows an embodiment of an electric machine stator in a perspective view;

FIG. 2 shows the embodiment of FIG. 1 in a sectional perspective view;

FIG. 3 shows an enlarged detail of FIG. 2 in a sectional view;

FIG. 4 shows a share of a coolant path through the embodiment of FIG. 1 in a sectional perspective view;

FIG. 5 shows two manifolds of the embodiment of FIG. 1 in a side elevation;

FIG. 6 shows an enlarged detail of the manifold in a perspective view.

### DESCRIPTION

This application discloses an electric machine stator comprising a stator core, a stator winding attached to the stator core, a plurality of cooling channels extending through the stator core, and manifolds for conveying a fluid into the cooling channels.

In FIG. 1, an embodiment of an electric machine stator 1 is depicted in a perspective view. The electric machine stator 1 comprises a stator core 2 with a stator winding attached to it. The winding heads 11 extend out of the stator core 2 at its axial ends 4 and are shown in FIGS. 1-3. The generally cylindrical stator core 2 defines a longitudinal axis L, which is depicted in FIG. 1. References like axial, radial or circumferential as used to describe any Figure, refer to the longitudinal axis L of the stator core 2 in FIG. 1 respectively, unless stated otherwise. A housing 12 according to the embodiment has two inlets 14 for a cooling fluid, the housing 12 encasing the stator core 2 and the winding heads 11. Two manifolds 3 are attached to opposed axial ends 4 of the stator core 2, of which only one is visible in FIG. 1. The manifolds 3 are arranged axially overlapping, radially outside the winding heads 11, and radially inside the housing 12. The manifolds 3 each have a gap 16 in the circumferential direction, a resilient member 17 being arranged between two surfaces facing the gap 16 and biassing the two surfaces apart. The manifolds 3 can be installed by reducing their radial dimension during insertion into the housing 12. The biassing force of the resilient member 17 provides for a tight fit of the manifolds 3 in the housing 12.

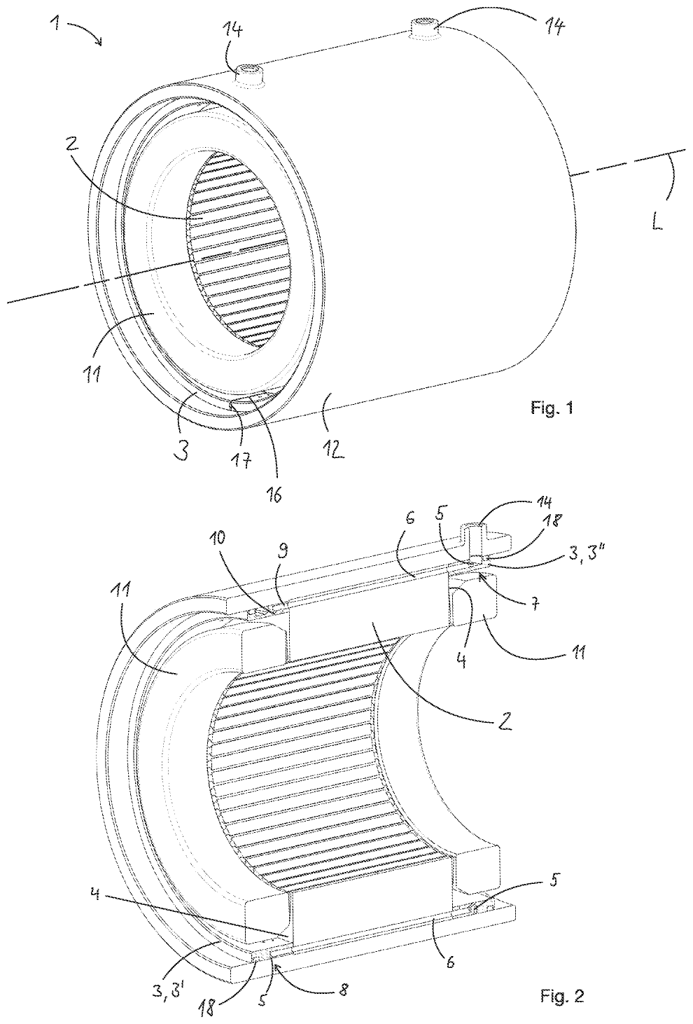

In FIG. 2, the embodiment of FIG. 1 is shown in a longitudinal section along the longitudinal axis L in a perspective view. A plurality of cooling channels 6 extend through the stator core 2, and the two manifolds 3 are attached to the opposed axial ends 4 of the stator core 2 for conveying the cooling fluid into the cooling channels 6. Gaskets 18 seal the manifolds against the housing 12. Each of the two manifolds 3, which may also be referred to as first manifold 3′ and second manifold 3″ has a distribution channel 5 hydraulically connected to a share of the cooling channels 6. A flow cross-section of the distribution channels 5 decreases along a circumferential main extension direction of the distribution channels 5. The cooling fluid is fed to the distribution channel 5 at a position of maximum flow cross-section 7. A position of minimum flow cross-section 8 of the distribution channel 5 is at an angular distance of about 180° from the position of maximum flow cross-section 7 on a circumference of the distribution channels 5.

The cooling channels 6 are evenly distributed about a circumference of the stator core 2, and connected hydraulically to one of the two manifolds 3 according to an alternating pattern, like A-B-A-B-A-B- etc, for example, or A-A-B-B-A-A-B-B- etc, or A-A-B-A-B-B-A-B-A-A-B-A- etc, with A representing a first share of the cooling channels 6 and B representing a second share of the cooling channels 6. In the depicted embodiment, the distribution channel 5 of the first manifold 3′ is connected to one of the cooling channels 6 at the position of minimum flow cross-section 8. The distribution channel 5 of the second manifold 3″ is connected to one of the cooling channels 6 at the position of maximum flow cross-section 7, where the inlet 14 is located. The inlets 14 are circumferentially shifted relative to each other by the distance between two adjacent cooling channels 6, which applies as well to the respective positions of maximum and minimum flow cross-section 7, 8. The stator core 2 can be mounted with the inlets 14 approximately in a position of maximum potential energy to allow a passive conveyance of the cooling fluid by gravitational force. The stator core 2 can be composed of a plurality of metal sheet laminations, which are advantageously identical.

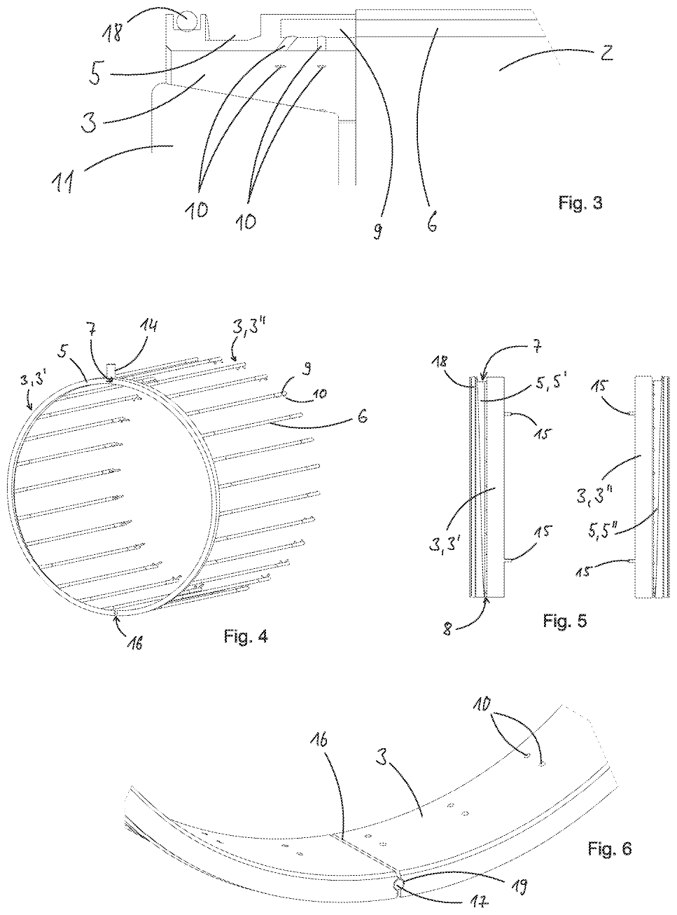

Each of the two manifolds 3 has outlet channels 9. The outlet channels 9 of the first manifold 3′ are hydraulically connected to the share of cooling channels 6 that are hydraulically connected to the distribution channel 5 of the second manifold 3″, and vice versa. The outlet channels 9 receive the cooling fluid from the respective cooling channels 6, which fluid is dispensed from the outlet channels 9 through at least one opening 10, which will be described with regard to FIG. 3.

In FIG. 3, an enlarged detail of FIG. 2 is shown in a sectional view without the housing 12. The openings 10 of the outlet channel 9 are directed towards the winding heads 11 extending out of the stator core 2 to dispense the cooling fluid onto the winding heads 11. The openings 10 of each outlet channel 9 have different axial positions to advantageously cover the winding heads 11. In the depicted embodiment, two openings 10 are provided per outlet channel 9 in different axial positions, one of the openings 10 being directed in radial direction perpendicular to the axial direction, and the other one of the openings 10 being directed in radial direction and angled to the axial direction. However, both openings 10 can be directed in radial direction perpendicular to the axial direction, as well. The distribution channel 5 is formed as a groove in the manifold 3, the groove being closed by the housing 12 encasing the stator core 2. The gasket 18 is also located in a groove axially outside of the distribution channel 5.

In FIG. 4, a coolant path through the embodiment of FIG. 1 is partly shown in a sectional perspective view. Depicted are the walls or surfaces bounding the coolant path from the first manifold 3′, which is fed via the inlet 14 and distributes the fluid into one of the shares of the cooling channels 6 comprising one half of the cooling channels 6. The downstream end is formed by the outlet channels with openings 10, which are formed by the second manifold 3″. The distribution channel 5 is generally circular, interrupted by the gap 16. The flow cross-section of the distribution channel 5 decreases from the inlet 14 or the position of maximum flow cross-section 7 in both circumferential directions.

In FIG. 5, the two manifolds 3 of the embodiment of FIG. 1 are shown in a side elevation. The flow cross-section of the distribution channels 5, which may be referred to as the first distribution channel 5′ in the first manifold 3′ and the second distribution channel 5″ in the second manifold 3″, decreases from a position of maximum flow cross-section 7 in both circumferential directions to the position of minimum flow cross-section 8. The distribution channels 5 can have a constant height in radial direction and a decreasing width in axial direction along the circumferential main extension direction. The manifolds 3 have positioning elements, e.g., positioning pins 15, mated with corresponding features in the stator core 2 to preserve a relative circumferential position with respect to the stator core 2.

In FIG. 6, an enlarged detail of the manifold 3 is shown in a perspective view. In the gap 16, a resilient member 17, for example in the form of a rubber seal, is arranged between the two surfaces facing the gap 16, the resilient member 17 being seated in respective grooves 19 in the surfaces. On an inner surface of the manifold, the openings 10 from the outlet channels are visible.

### REFERENCE NUMERALS

1 Electric machine stator
2 Stator core
3 Manifold
3′ First manifold
3″ Second manifold
4 Axial end
5 Distribution channel
5′ First distribution channel
5″ Second distribution channel
6 Cooling channel
7 Position of maximum flow cross-section
8 Position of minimum flow cross-section
9 Outlet channel
10 Opening
11 Winding heads
12 Housing
14 Inlets
15 Positioning pins
16 Gap
17 Resilient member
18 Gasket
19 Groove
L Longitudinal axis

1.-10. (canceled)

11. Electric machine stator comprising:
a stator core, a stator winding attached to the stator core, a plurality of cooling channels extending through the stator core, and two manifolds attached to opposed axial ends of the stator core for conveying a fluid into the cooling channels,
each of the two manifolds having a distribution channel hydraulically connected to a share of the cooling channels,
wherein a flow cross-section of the distribution channel decreases along a circumferential main extension direction of the distribution channel.

12. Electric machine stator according to claim 11, wherein the distribution channel is circular, and the flow cross-section of the distribution channel decreases from a position of maximum flow cross-section in both circumferential directions, wherein the fluid is fed to the distribution channel at the position of maximum flow cross-section.

13. Electric machine stator according to claim 12, wherein a position of minimum flow cross-section of the distribution channel is at an angular distance of about 180° from the position of maximum flow cross-section on a circumference of the distribution channel.

14. Electric machine stator according to claim 11, wherein the cooling channels are evenly distributed about a circumference of the stator core, and connected hydraulically to one of the two manifolds according to an alternating pattern.

15. Electric machine stator according to claim 11, wherein each of the two manifolds has outlet channels hydraulically connected to the share of cooling channels that are hydraulically connected to the distribution channel of the respective other one of the two manifolds, to receive the fluid from said share of cooling channels, wherein the outlet channels have at least one opening for dispensing the fluid.

16. Electric machine stator according to claim 11, wherein the distribution channel is formed as a groove in the manifold, the groove being closed by a housing encasing the stator core, wherein the housing has at least one inlet hydraulically connected to at least one of the distribution channels.

17. Electric machine stator according to claim 16, wherein in a mounted position, the at least one inlet is arranged in a position of maximum potential energy.

18. Electric machine stator according to claim 11, wherein the manifolds have a positioning element to preserve a relative circumferential position with respect to the stator core.

19. Electric machine stator according to claim 11, wherein the manifolds each have a gap in the circumferential direction, a resilient member being arranged between two surfaces facing the gap and biassing the two surfaces apart.

20. Electric machine stator according to claim 11, wherein the stator core is composed of a plurality of identical laminations.
